(19) United States
(12) Patent Application Publication
(10) Pub. No.: US 2008/0212590 A1
(43) Pub. Date: Sep. 4, 2008

(54) Flexible protocol engine for multiple protocol processing

(75) Inventor: Andrew Stanley-Jones, Tippecanoe, IN (US)

Correspondence Address: BAKER & DANIELS LLP, 300 NORTH MERIDIAN STREET, SUITE 2700, INDIANAPOLIS, IN, 46204, US

(73) Assignee: ImageStream Internet Solutions, Plymouth, IN (US)

(21) Appl. No.: 11/713,043

(22) Filed: Mar. 2, 2007

(51) Int. Cl. H04L 12/56

(52) U.S. Cl. 370/395.5

(57) ABSTRACT

Embodiments of the invention relate to a flexible protocol engine for operation with multiple communication protocols. The flexible protocol engine may include a programmable protocol processor operable to process data by implementing a selected technique, the selected technique selectable from multiple selectable techniques. Each of the multiple selectable techniques may correspond to a distinct communication protocol. The flexible protocol engine may also include a first interfacing component operatively connecting the programmable protocol processor to a transceiver device and a second interfacing component operatively connecting the programmable protocol processor with a host device.

### TECHNICAL FIELD

Embodiments of the present invention relate to processing of data in multiple communication protocols. More particularly, embodiments of the invention are directed to processing of data from various protocols using a single flexible processing device.

### BACKGROUND OF THE INVENTION

Currently, in order to process data conforming to multiple distinct communication protocols, custom hardware is often required for each protocol. For example, specific hardware may be required for a High Level Data Link Control (HDLC) processor, an Asynchronous Transfer Mode (ATM) processor or for a voice processor for telephony applications. Thus, each of these applications may require a different interface card.

The different communication protocols require different formats for communicating data. For example, HDLC is a bit-oriented synchronous data link layer protocol. Until recent years, most data was moved through HDLC. HDLC is the basis for a synchronous point to point protocol used by many servers to connect to a WAN, most commonly the Internet. The structure of an HDLC frame includes an eight bit flag, followed by an eight bit address. A control following the address may be eight or sixteen bits. Information of variable length in multiples of eight bits may follow the control. A frame check sequence (FCS) of sixteen bits and an optional flag of eight bits may also be included. The FCS is implemented to detect transmission errors. By checking the FCS, a receiver can discover bad data.

Ultimately, it became desirable to provide voice applications and data applications on the same line. This objective is difficult to accomplish when using the HDLC protocol. Also, it became desirable to provide virtual channels on the same line so that a user could communicate with multiple users over a single line. To meet these requirements, the ATM protocol was developed. ATM is a cell relay data link layer protocol which encodes data traffic into small fixed cells. These cells include fifty three bytes, forty eight of those bytes including data and five bytes including header information. These cells take the place of variable sized packets, also known as frames, which are used in packet switched networks such as Internet Protocol or Ethernet. ATM is a connection oriented technology, in which a connection is established between two endpoints before actual data exchange begins.

Thus, as illustrated by these examples, protocol processing is typically required to be protocol specific. Hardware that processes HDLC is typically unable to process the cells of ATM. Other additional protocols exist that require differentiated processing. For example, SS7, which is common in telephone applications, involves re-transmission of small packets of data frequently.

In addition to handling multiple protocols, a system is needed that can be adapted to operate multiple physical interfaces. Interfaces provided by the telephone company and cable companies have different characteristics and often need different hardware with each one of the different line interfaces provided. For example, a synchronous serial interface (SSI) is typically implemented with a T1 line and a high speed serial interface (HSSI) is typically implemented with a DS3 interface or T3 line.

Various solutions have been developed for processing data from multiple protocols. One technique for processing data transmitted in different protocols is to include a dedicated processor on a Wide Area Network (WAN) card. The processor may take the form of a Digital Signal Processor (DSP) or Central Processing Unit (CPU). This dedicated processing component has added cost and furthermore consumes a large amount of RAM. While this strategy may be effective for high end boards such as an OC-3 board, it is not cost effective for the more common T1 boards or DS3 boards.

Another technique for avoiding the necessity for custom hardware is to move processing from the line interface card and pass all data to a host CPU for processing. While this technique may be effective for some slow speed links, the host CPU may run out of processing cycles due to the nature of the processing required.

Thus, currently available solutions for processing multiple protocols and adapting to multiple physical interfaces are both expensive and inefficient. Thus, a flexible and cost effective solution is needed for processing data from multiple protocols.

Open System Interconnection (OSI) architecture provides a model of layers for protocol processing. The first two layers tend to be hardware oriented. The first layer is typically referred to as a physical layer that includes electrical signaling and cabling. The second layer is a data link Media Access Control (MAC) layer that transmits packets from node to node based on a station address. Various protocol processing functions, such as the generation of Cyclic Redundancy Checks (CRCs), serialization, and byte ordering can be accomplished with hardware easily. Thus, the use of host CPU time should be largely unnecessary.

Over the last few years, programmable electronic hardware components such as Field Programmable Gate Arrays (FPGAs) have become less expensive. Accordingly, a solution is needed that exploits readily programmable electronic hardware devices for protocol processing. Implementation of such devices would minimize the expense of providing custom hardware for protocol processing and would further avoid slow-down of the host CPU.

### BRIEF SUMMARY OF THE INVENTION

In one aspect, a method is provided for processing data formatted for multiple communication protocols with a single flexible protocol engine. The method may include downloading programming information corresponding to an existing communication protocol from a device driver to the flexible protocol engine. The method may additionally include implementing the programming information within the flexible protocol engine to facilitate processing of data in accordance with the existing communication protocol.

In a further aspect, a flexible protocol engine is provided for operation with multiple communication protocols. The flexible protocol engine is operatively connected with a line interface unit and a device interface and includes multiple programming components. The multiple programmable components may include a programmable protocol processor for receiving and implementing selected programming from the device, the selected programming determined based upon an existing communication protocol among the multiple communication protocols.

In an additional aspect, a flexible protocol engine may be provided for operation with multiple communication protocols. The flexible protocol engine includes a programmable protocol processor operable to process data by implementing a selected technique, the selected technique selectable from multiple selectable techniques, each of the multiple selectable techniques corresponding to a distinct communication protocol. The flexible protocol engine may also include a first interfacing component operatively connecting the programmable protocol processor to a transceiver device and a second interfacing component operatively connecting the programmable protocol processor with a host device.

In an additional aspect, an interface card is provided for operation with multiple communication protocols. The interface card includes a flexible protocol engine operable to process data by implementing a selected technique, the selected technique selectable from multiple selectable techniques, each of the multiple selectable techniques corresponding to a distinct communication protocol. The interface card additionally includes a line interface unit operatively connecting the flexible protocol engine with remote locations and an additional interfacing device operatively connecting the flexible protocol engine with a host device.

### BRIEF DESCRIPTION OF THE DRAWINGS

The present invention is described in detail below with reference to the attached drawings figures, wherein:

FIG. 1 is a block diagram illustrating a flexible protocol engine environment in accordance with an embodiment of the invention;

FIG. 2 is a block diagram illustrating components of a flexible protocol engine in accordance with an embodiment of the invention;

FIG. 3 is a flow chart illustrating a method for implementing the flexible protocol engine to adapt to a communication protocol in accordance with an embodiment of the invention;

FIG. 4 is a flow chart illustrating a generalized method for processing received data in accordance with an embodiment of the invention;

FIG. 5 is a flow chart illustrating a generalized method for processing data for transmission in accordance with an embodiment of the invention;

FIG. 6 is a flow chart illustrating a method for receiving HDLC data in accordance with an embodiment of the invention;

FIG. 7 is a flow chart illustrating a method for transmitting HDLC data in accordance with an embodiment of the invention;

FIG. 8 is a flow chart illustrating a method for receiving ATM data in accordance with an additional embodiment of the invention; and

FIG. 9 is a flow chart illustrating a method for transmitting ATM data in accordance with an additional embodiment of the invention.

### DETAILED DESCRIPTION OF PREFERRED EMBODIMENTS

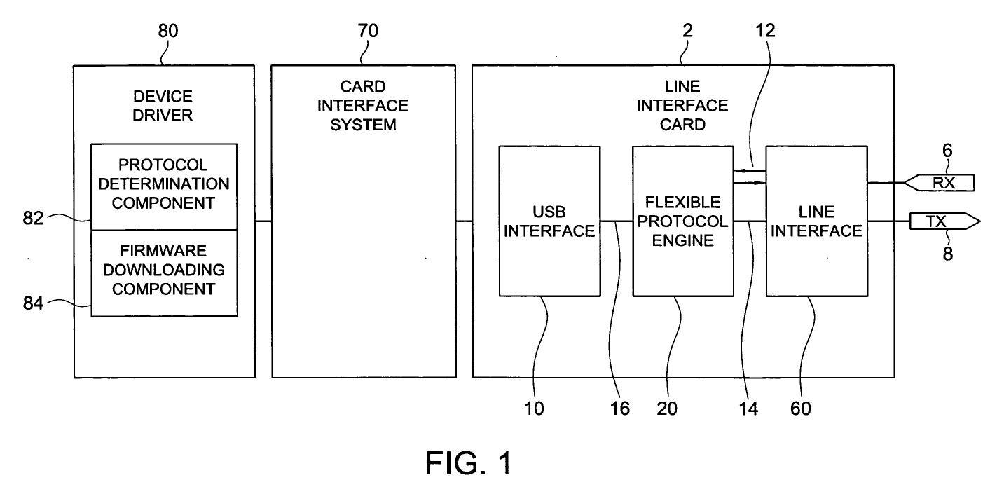

FIG. 1 is a block diagram illustrating components of a flexible protocol engine environment in accordance with an embodiment of the invention. The components shown may be disposed within or operatively connected with a router through which data is received and transmitted. The router may be located within consumer premise equipment (CPE). CPE is telephone or other service provider end-user equipment that is located on the customer's premises or physical location rather than on the provider's premises or in between. Telephone handsets, cable TV set-top boxes, and digital subscriber line routers are examples of CPE.

In alternative embodiments, the components may be located in or connected with a router at network operation center. The network operation center may, for example, connect with multiple data lines from outside sources. The displayed components would be available to track data flow between service providing companies and main network links.

As illustrated in FIG. 1, a device driver 80 is connected with an interface system 70 for interfacing with an interface card 2. In embodiments of the invention, the interface card 2 may include an interface 10 which may be a universal serial bus (USB) interface, connected with a flexible protocol engine (FPE) 20, and a LIU 60. Data may be transmitted to outside devices through line 8 and received from outside devices through line 6.

The device driver 80 may be stored as router software in a memory disposed within a router or in communication with a router and may include or access a protocol determination component 82 and a firmware downloading component 84. When the device driver 80 loads, such as upon powering up of the device, the device driver 80 may implement the protocol determination component 82 to check the required protocol and the firmware downloading component 84 for downloading appropriate programming information to the FPE 20, and optionally to other components within the interface card 2. In other embodiments, such as when the existing protocol is manually confirmed and selected, the protocol determination component 82 is unnecessary.

The interface card 2 may be an exchangeable expansion card used inside of a router and connected with a motherboard. In order to connect with the interface card 2, a router port connection may be established.

Within the line interface card 2, the interface 10 communicates with the router operatively connected with the CPE or other host device. Although the interface 10 shown is a USB interface, serial, parallel, or other known types of interfaces may also be implemented. The LIU 60 connects the line interface card 2 with outside devices through the receiving line 6 and the transmission line 8.

Within the interface card 2, data lines 12 allow data to pass between the FPE 20 and the LIU 60. A control line 14, which may, in embodiments of the invention be an eight bit wide interface, allows controls to pass between the LIU 60 and FPE 20. An interface 16 may connect the FPE 20 with the USB interface 10, and may in embodiments of the invention be an eight bit wide FIFO interface. This interface 16 may have four virtual channels to connect with four high speed USB endpoints, which will be further described herein.

In one preferred embodiment of the invention, the USB interface 10 is based on a Cypress™ CY7C68013, which is a USB interface chip with an embedded 8051 CPU, 8 k of RAM, and a USB line interface with buffering. In this embodiment, the USB interface 10 provides all required USB handshaking and a high speed interface to the FPE 20 via an eight bit parallel interface. Although specific details of the interface chip 10 are not shown, the USB interface 10 may have four virtual channels to connect the four high speed USB endpoints. In a preferred embodiment, endpoint two is the transmit data channel and endpoint six is the receive data channel. Endpoints four and eight are used to communicate with the FPE 20 and LIU 60 to issue commands or change the mode of operation.

To enable control and programming, the USB interface 10 provides a local endpoint one that allows communication directly with the 8051 CPU to issue requests or change operation. Packets may be limited to sixty four bytes. In each command, the first byte functions as a command identifier and the following bytes include arguments or data. The USB interface 10 returns a single packet as an answer. The first byte is a result code and any following bytes are data. This functionality may be used to verify USB operation, enable linear regulators, and program the FPE 20.

The USB interface 10 must be programmed when it connects to the USB. The Cypress™ device provides a 4 k program space for the 8051 to execute from. The code sets up the USB interface 10, powers on the board, and provides a method of programming the FPE 20. The programming for the USB interface 10 is preferably the same for all boards and protocols.

The FPE 20 within the line interface card 2 includes an FPGA containing programmable logic components and programmable interconnects. The programmable logic components can be programmed to duplicate the functionality of basic logic gates such as AND, OR, XOR, NOT or more complex combinational functions such as decoders or simple math functions. In most FPGAs, these programmable logic components can also include memory elements, which may be simple flip-flops or more complete blocks of memories. A hierarchy of programmable interconnects allows the logic blocks of an FPGA to be interconnected as needed. These logic blocks and interconnects can be programmed after the manufacturing process by a customer or designer so that the FPGA can perform whatever logical function is needed.

The typical architecture includes an array of configurable logic blocks and routing channels. An FPGA can be reprogrammed while in operation and this reprogramming capability provides the flexibility to change the protocol processing. The use of an FPGA can allow one card to process data from multiple protocols including HDLC, ATM, voice, or any other custom protocol required without pushing the processing load to the host CPU. The FPE 20 provides all the glue logic required to connect all of the hardware together and simplifies the line interface card 2 by reducing the part count and cost.

In one preferred embodiment the FPE 20 is a Xilinx™ XC3S400-144 FPGA, which requires programming to operate every time it is powered on. In this embodiment, data may be exchanged with the USB interface 10 over an eight bit wide interface with four virtual channels. The FPE 20 serializes the transmit data, adds protocol headers and CRCs. When there is no data to transmit, the FPE 20 generates idle line fill. The output from the FPE 20 is serial data and clock data to the LIU 60. For received data, the data arrives as a serial stream that the FPE 20 must packetize, verify CRCs, and transmit to the USB interface 10 in parallel form.

In order to control the FPE 20, commands may be sent to the FPE via endpoints of the USB interface 10. In a preferred embodiment implementing the Cypress™ chip and Xilinx™ FPGA, the commands may be sent via endpoint four and answers returned on endpoint eight. The command structure may include target, address, and data information. The target bits may include a bit for LIU or FPE selection, a read/write bit, and a flush bit for flushing output on command completion in order to define and generate a packet. The address information is included for both read and write commands. The data portion is required only for write commands. A single byte may be returned including the contents of the data lines during the operation.

The LIU 60 converts analog input to a digital signal, recovers the clock, locates framing data, and provides digital serial data output to the FPE 20. Communication between the LIU 60 and FPE 20 varies depending on the physical interface type. Thus the LIU 60 may be an interchangeable unit including several lines for connection with the FPE 20. The LIU 60 may require setup, and/or downloading of tables for proper operation. Setup can be accomplished via a register read/write interface provided by the FPE 20. Commands are sent to the LIU 60 similarly to the method described below for the FPE 20. In embodiments of the invention, to allow for more efficient transfer of data, multiple commands can be sent sequentially and answers will be returned in order in a single packet. For instance, with a packet size limit of sixty four bytes and a query size of three bytes, twenty one commands can be sent.

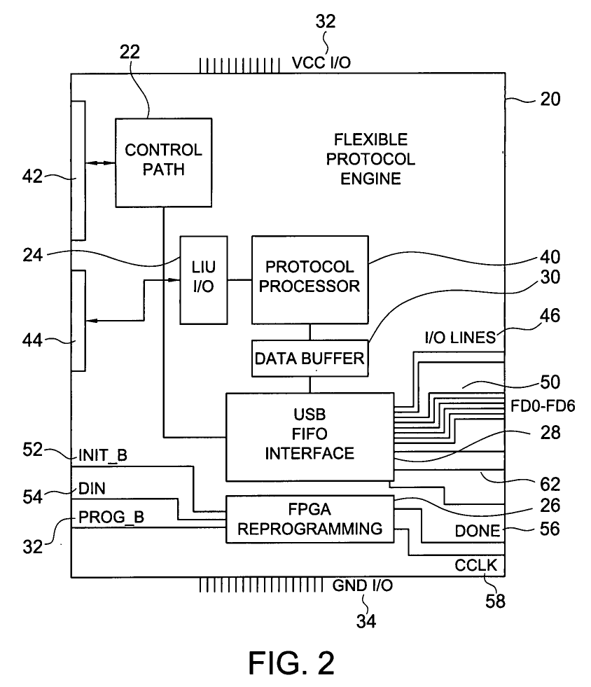

FIG. 2 is a schematic diagram illustrating the FPE 20 in accordance with an embodiment of the invention. The FPE 20 may include a control path 22, a line interface unit input/output 24 (LIU I/O), a protocol processor 40, and a data buffer 30. The flexible protocol engine 20 may additionally include a USB FIFO interface 28 and an FPGA reprogramming section 26. Various input/output lines, such as 42, 44, 46, 48, 50, 52, 54, 56, 58, and 62 are additionally shown. Four of the displayed lines, including the DONE line 56, the CCLK line 54, the DIN line 54, and the Prog_B line 32, connect with the USB interface 10 to download new firmware from the driver 80. Additionally, the Init_B line 52 may allow a reset operation to be triggered in order to clear the FPGA. Lines 50 (FD0-FD6) are data transmission lines for operation between the USB interface 10 and the FPE 20. Generalized Power or VCC input/output pins 32 and generalized Ground I/O pins 34 are also shown. These pins may take on a number of different configurations. As set forth above, the FPE 20 may be constructed from a Xilinx™ FPGA, such as the XC3S400-144.

Thus, the internal structure of the FPE 20 may be broken in to six major sections. Five of the sections, including the control path 22, LIU I/O 24, protocol processor 40, data buffer 30, and USB FIFO interface 28 are programmable. The other section, the FPGA reprogramming section 26, is fixed.

The protocol processor 40 changes based on the protocol in use, for example ATM, HDLC, or SS7. For data transmission, the protocol processor 40 reads data from the data buffer 30 and processes the data as required for delivery to the LIU 60 through the illustrated LIU I/O 24. For data reception, the protocol processor 40 reads serial data from the LIU 60 and packetizes the data. The protocol processor 40 also verifies CRCs and places them in a the data buffer 30 for transmission over the USB through the USB FIFO interface 28.

The LIU I/O unit 24 takes a data stream from the protocol processor 40 and transmits it to the LIU 60. The LIU I/O 24 changes based on the physical interface type such as T1, DS3, T1/E1, SSI, etc. but is not required to change based upon the protocol in use. The LIU I/O 24 interfaces the serial stream data to and from the LIU 60 and ensures that timing requirements and break requirements are met. Depending on the physical interface, each LIU 60 may have different requirements. Some require a framing pulse while others may require hardware handshaking. For instance, on a T1 line, a one bit break is included to allow for transmission of a framing bit after every 192 bits. The DS3 physical interface has other requirements for breaks and timing.

The control path logic 22 also may be variously configured based on the physical interface type. Systems with complicated physical interfaces such as T1, DS3 and Asymmetric Digital Subscriber line (ADSL) require the device driver 80 in the router to setup the LIU 60. Such setup might be for line type, signal requirements by a telephone company, line length, etc. In a preferred embodiment implementing the Xilinx FPGA and the Cypress USB, the control path logic 22 provides an interface to the driver 80 that uses USB endpoints four and eight. Additionally, the control path logic 22 provides a register map to the driver 80. This allows the driver 80 to read or write to the LIU 60 as if it were registers. For example, to determine line status, the driver 80 might read address zero or to obtain alarm information, the driver 80 may read address one. The FPE 20 provides the logic to convert the interface on the LIU 60 into this register map.

The USB FIFO interface 28 is constant through all firmware downloaded to the FPE 20 and retrieves bulk data from the USB interface 10. The USB FIFO interface 28 may send data to the data buffer 30 and provide packets without breaks to the protocol processor 40. The USB FIFO interface 28 provides the glue between the USB interface 10 and protocol processor 40 and separates the four different endpoints from one bus into four different data streams. The transmission and reception data paths are routed through the data buffer 30 and control queries and answers are sent to the control path logic 22.

The FPE reprogramming section 26 is a standard feature of an FPGA. When reset is applied via the init_b line 52, the contents of the FPGA 20 are cleared such that the FPGA 20 will then accept new programming. Data is transferred to the FPGA 20 via the DIN line 54 and CCLK line 58. When all the new firmware is downloaded and verified, the DONE line 56 is raised. The FPGA 20 then starts operation as an FPE 20.

The data buffer 30 provides smoothing functionality as USB traffic may suffer from gaps and breaks. Synchronous lines cannot tolerate breaks within a packet. If data is not continuously transmitted, packets may be corrupted. The data buffer 30 smooths the data flow so that the protocol processor 40 is immune from these breaks. With USB, breaks can be one millisecond or more. For a T1 line operating at 1.536 mbit (1.536×10⁶), the data buffer 30 must be able to hold at least 1.536×10³ bits, or in other words 192 bytes. As such, for this type of line 256 bytes is a convenient buffer size and allows for a margin of safety. In embodiments of the invention, independent buffers may be provided for the transmit and receive sides. The receive side may also experience breaks and thus requires buffering until the USB FIFO interface 28 can accept the data. The data buffer 30 is constant for all downloaded firmware across protocols.

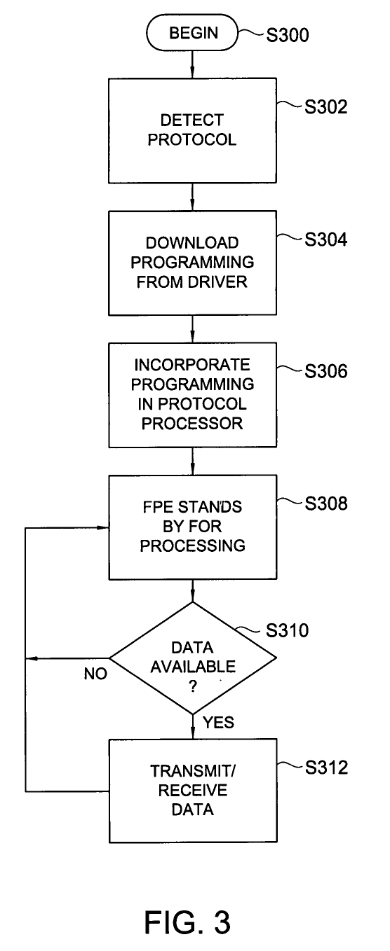

FIG. 3 is a flow chart illustrating a method of operation in accordance with an embodiment of the invention. The process begins in S300, and the system may detect a protocol in S302. When the driver loads, it then may check the protocol required. In response to the detection of a protocol, in S304, programming is downloaded from the driver. The FPE is programmed based on the protocol selection. Alternatively, the existing protocol may be manually determined or selected and the programming may be downloaded accordingly. Although programming can be changed selectively, downloading new code may consume about 300 ms, thus interrupting the data flow. Programming the FPE may be done indirectly via the USB interface chip. The FPE must have the data loaded serially, so the data is transferred to the USB interface, which then transmits the bits to the FPE programming interface. Configuring the FPE in this manner saves having an expensive EEPROM, and it also allows the FPE to be reconfigured easily for different protocol support. In S306, the downloaded programming is incorporated in the protocol processor. Should a client have a custom protocol or old protocol that no hardware can decode, a custom protocol module can be loaded. The FPE can be reprogrammed to easily decode packets and deliver them to the system efficiently.

Once the programming is incorporated, the FPE stands by for processing in S308. If data is available in S310, the FPE processes the data as required in order to transmit and receive data in S312. For the HDLC protocol, the FPE will generate idle bytes, check CRCs, packetize data, and deliver or transmit packets. If the FPE is programmed for ATM protocol processing it will delineate cells, generate idle cells, verify CRCs, and deliver ATM data cells to the system. As set forth above, dealing with cells is a completely different mode of operation that hardware capable of doing HDLC typically does not allow. If no data is available in S310, the FPE continues to stand by for processing. At any time, a different protocol may be detected, thus requiring downloading of different programming.

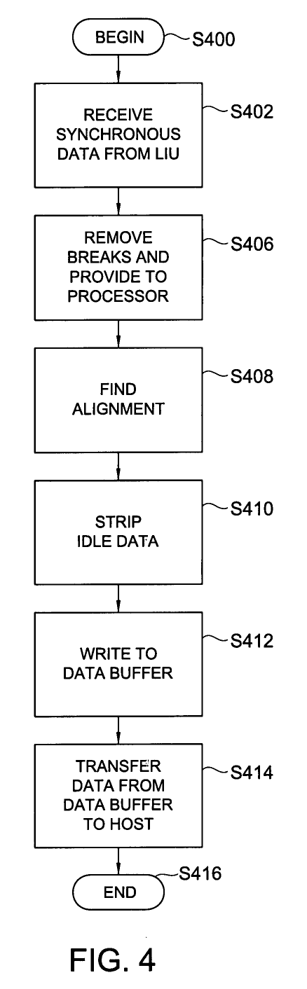

FIG. 4 illustrates a generalized receive scenario in accordance with an embodiment of the invention. The process begins in S400. In S402, the FPE receives synchronous data from the LIU, which converts the input to digital input if necessary. The exact configuration and conversion necessary is dependent upon the existing protocol. In S406, the FPE removes breaks and provides the data to the protocol processor. Specifically, the LIU I/O receives synchronous data from the LIU, removes breaks, and transmits the data as a continuous raw stream to the protocol processor. In S408, the protocol processor finds alignment and in S410, the processor strips idle data. In S412, the protocol processor writes the data to the data buffer when a valid packet is detected and in S414, the data buffer indicates to the USB FIFO interface that data is available to the router and the data is transferred from the data buffer to the host device. The output from the FPE is byte wise to the USB interface and in embodiments of the invention may use the USB FIFO interface as endpoint number six. The system may then use standard USB data routines to receive the packet. The USB interface transparently passes all data from the FPE.

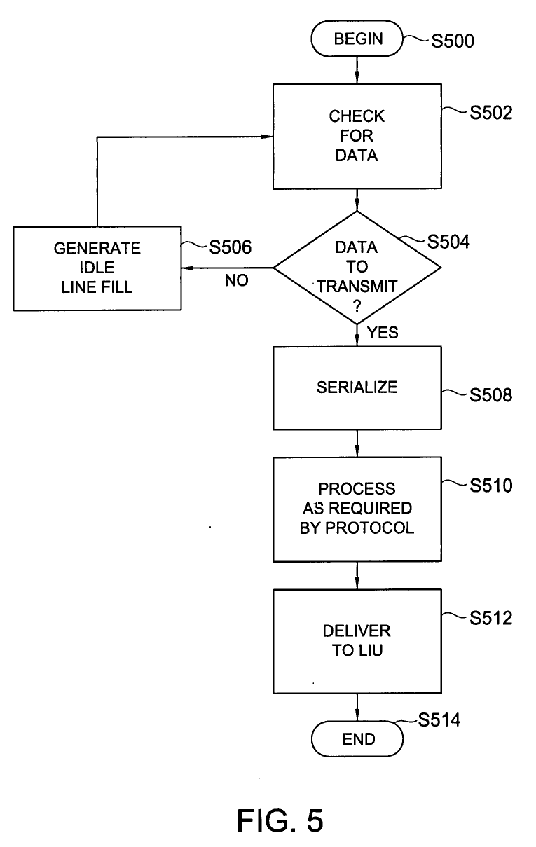

FIG. 5 illustrates a generalized transmit strategy in accordance with an embodiment of the invention. The process begins in S500 and the FPE checks for data in S502. For instance, in a transmission mode, the USB interface receives the data from the router and forwards it unchanged to the FPE, for example via the USB FIFO interface within the FPE. The packet travels through the USB interface and a arrives a byte at a time at I/O lines FD0 through FD6, where endpoint two may be selected. In embodiments of the method, the USB interface is provided with a packet in a predetermined format through endpoint two. The USB FIFO interface loads the bytes into the data buffer. All bytes in one packet are loaded into the data buffer and the end of the packet is flagged. If no data is available to transmit in S504, the protocol processor generates idle line fill in S506. If data is available to transmit in S504, the protocol processor serializes the data in S508 and subsequently processes the data as required by the detected protocol in S510. This may involve appending headers to data, calculating checksums, and adding closing headers. In S512, the processed data is delivered to the LIU. Data received from the FPE has framing added and is converted to an analog output by the LIU. Ultimately, output from the LIU is fed through lightning/surge protection and output from the interface card and the process ends in S514.

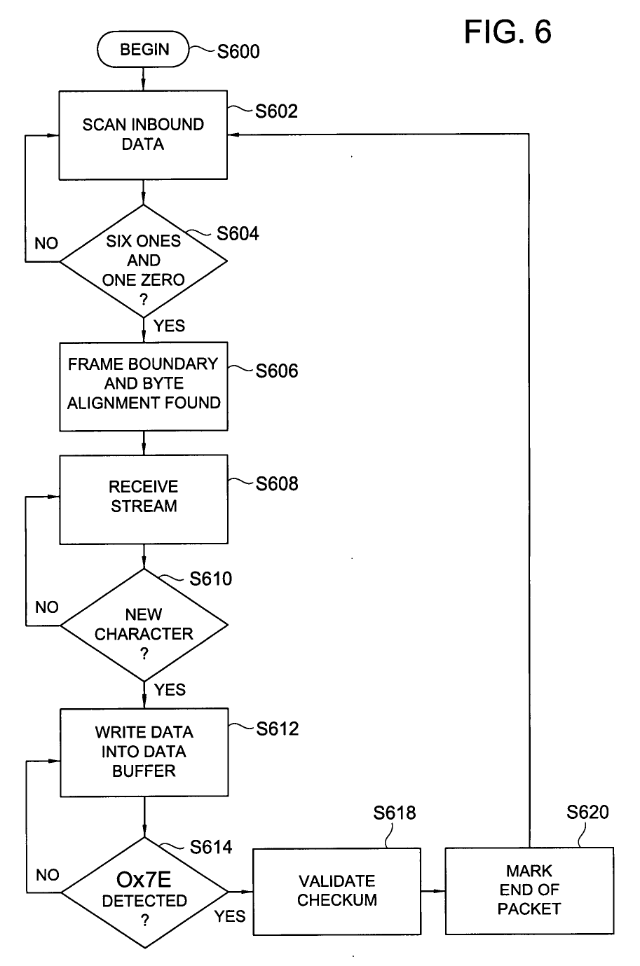

FIG. 6 illustrates a method of receiving HDLC data. The method begins in S600 and the protocol processor scans inbound data in S602. If the inbound data does not include six ones and one zero in S604, the protocol processor continues to scan inbound data in S602. If the inbound data includes six ones and one zero in S604, then the protocol processor finds a frame boundary and byte alignment in S606. In step 608, the protocol processor receives a stream. If the stream does not contain a new character in S610, the protocol processor continues to receive the stream in S608. If the new character is found in S610, then the protocol processor writes data into the data buffer in S612. The protocol processor then looks for 0x7e in S614 and continues to write data into the data buffer until 0x7e is detected in S614. If 0x7e is detected in S614, the protocol processor validates the checksum in S618. In S620, the protocol processor marks the end of the packet and returns to scan inbound data in S602.

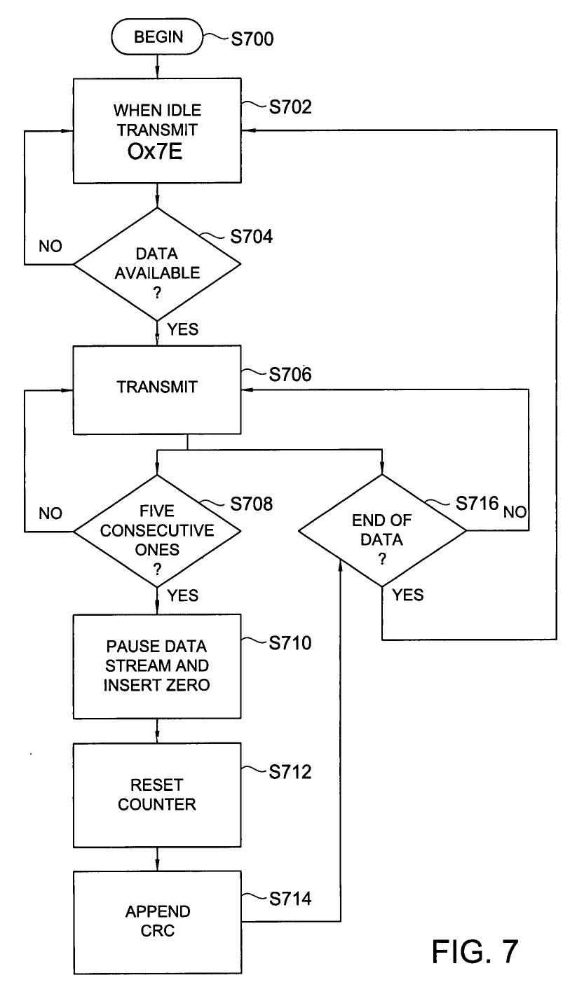

FIG. 7 illustrates a transmission method for HDLC in accordance with an embodiment of the invention. The process begins in S700 and when idle, the protocol processor transmits 0x7e in S702. If data is available for transmission in S704, the protocol processor terminates the current 0x7e and begins transmission in S706. If five consecutive ones are contained in the stream in S708, the protocol processor pauses the data stream and inserts a zero as the next transmit character in S710. For example, the series of bits 000101111111, would be transmitted as 00010101111011. Once the next character is transmitted, in S712, the protocol processor resets the counter and appends the CRC in S714. The CRC may be sixteen bits or thirty two bits and may be appended and transmitted on the line. The protocol processor repeats S706-714 unless the end of the data is found in S716. When the end of data is found, he protocol processor becomes idle again in S702.

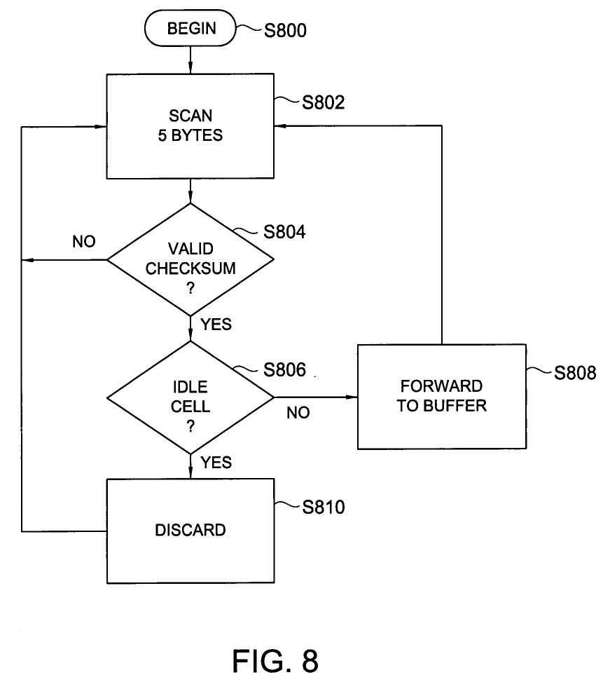

FIG. 8 illustrates a receiving method implemented with the ATM communication protocol in accordance with an embodiment of the invention. The method begins in S800. The protocol processor scans five bytes in S802. In S804, the protocol processor determines whether a checksum is valid and the cell is valid. If the checksum is not valid in S804, the protocol processor continues by again scanning five bytes. If the check sum is valid in S804, the protocol processor searches for an idle cell in S806. If the idle cell is found in S806, it is discarded in S810. If the idle cell is not found in S806, the data is forwarded to the buffer in S808 and the scanning of bytes continues in S802.

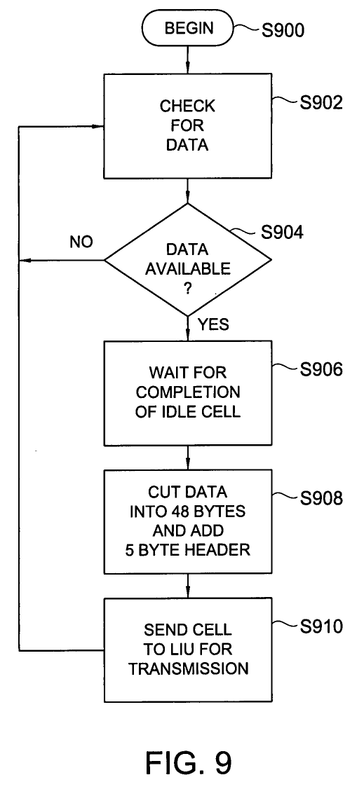

FIG. 9 illustrates an ATM transmission method in accordance with an embodiment of the invention. The method begins in S900 and the protocol processor checks for data in S902 while transmitting a fifty three byte four hundred twenty four bit long idle cell. It computes CRCs as required and transmits the cell until data is available. If data is available in S904, the protocol processor waits for completion of an idle cell in S906. However, with ATM, the protocol processor may have to wait for 424 bits which on T1 may take up to 276 us. In S908, the protocol processor cuts the data into forty eight bytes and adds a five byte header. In S910, the system sends the cell to the LIU for transmission.

Reassembly of cells into full data packet can become very complicated as such data cells are simply forwarded to the host. Doing ATM processing in the FPE saves the host a huge amount of CPU work since checksums and cell validation can be done in the FPE. An ATM T1 would be processing 7200 cells/second, even when idle. With the FPE, the host simply transmits packets and reassembles data cells.

In summary, the reconfigurable FPE transmits packets to the LIU and receives packets from the USB interface. The FPE generates CRCs, changes the bit order, and/or creates cells as required by the protocol. This level of bitwise processing is very time consuming for a general purpose processor, but can be efficiently accomplished with hardware like the FPE. Since the FPE can be easily reprogrammed, different programming for protocol processing can easily be downloaded by the driver as required.

While particular embodiments of the invention have been illustrated and described in detail herein, it should be understood that various changes and modifications might be made to the invention without departing from the scope and intent of the invention.

From the foregoing it will be seen that this invention is one well adapted to attain all the ends and objects set forth above, together with other advantages, which are obvious and inherent to the system and method. It will be understood that certain features and sub-combinations are of utility and may be employed without reference to other features and sub-combinations. This is contemplated and within the scope of the appended claims.

What is claimed is:

1. A method for processing data formatted for multiple communication protocols with a single flexible protocol engine, the method comprising:
downloading programming information corresponding to an existing communication protocol from a device driver to the flexible protocol engine; and
implementing the programming information within the flexible protocol engine to facilitate processing of data in accordance with the existing communication protocol.

2. The method of claim 1, further comprising implementing a device driver for detecting the existing communication protocol.

3. The method of claim 1, further comprising detecting one of an HDLC and an ATM communication protocol.

4. The method of claim 1, further comprising programming a protocol processor in the flexible protocol engine based on the existing communication protocol.

5. The method of claim 4, further comprising downloading programming to the protocol processor through a USB interface.

6. The method of claim 1, wherein implementing the programming information comprises removing breaks from received data, finding alignment, and stripping idle data.

7. The method of claim 6, further comprising transferring received data to a data buffer.

8. The method of claim 7, further comprising transferring the received data from the data buffer to a host device.

9. The method of claim 1, wherein implementing the programming information comprising serializing data for transmission, processing data as required by the detected protocol, and delivering the processed data to a line interface unit.

10. A flexible protocol engine for operation with multiple communication protocols, the flexible protocol engine comprising:
a programmable protocol processor operable to process data by implementing a selected technique, the selected technique selectable from multiple selectable techniques, each of the multiple selectable techniques corresponding to a distinct communication protocol;
a first interfacing component operatively connecting the programmable protocol processor to a transceiver device; and
a second interfacing component operatively connecting the programmable protocol processor with a host device.

11. The flexible protocol engine of claim 10, wherein the first interfacing component comprises a line interface unit I/O for delivering data to a line interface unit and receiving data from the line interface unit.

12. The flexible protocol engine of claim 10, further comprising at least one data buffer for smoothing data flow.

13. The flexible protocol engine of claim 12, further comprising a first data buffer for smoothing data flow for received data and a second data buffer for smoothing data flow for transmitted data.

14. The flexible protocol engine of claim 10, wherein the flexible protocol engine comprises a programmed FPGA.

15. The flexible protocol engine of claim 14, further comprising a fixed FPGA reprogramming section.

16. The flexible protocol engine of claim 15, further comprising an input line for allowing resetting of the FPGA through the FPGA reprogramming section.

17. The flexible protocol engine of claim 10, wherein the second interfacing component comprises a USB FIFO interface for retrieving data from a USB interface and for delivering data to the USB interface.

18. The flexible protocol engine of claim 10 further comprising a control path for providing an interface to a driver.

19. The flexible protocol engine of claim 10 further comprising at least one input/output line for accepting programming from a firmware downloading component associated with a device driver.

20. A flexible protocol engine for operation with multiple communication protocols, the flexible protocol engine operatively connected with a line interface unit and a device interface, the flexible protocol engine comprising:
multiple programmable components including a programmable protocol processor for receiving and implementing selected programming from the host device, the selected programming determined based upon a selected communication protocol among the multiple communication protocols.

21. The flexible protocol engine of claim 20, wherein the multiple programmable components further comprise a line interface unit I/O for delivering data to a line interface unit and receiving data from the line interface unit.

22. The flexible protocol engine of claim 20, further comprising at least one data buffer for smoothing data flow.

23. The flexible protocol engine of claim 22, further comprising a first data buffer for smoothing data flow for received data and a second data buffer for smoothing data flow for transmitted data.

24. The flexible protocol engine of claim 20, wherein the flexible protocol engine comprises a programmed FPGA.

25. The flexible protocol engine of claim 20, further comprising a fixed FPGA reprogramming section.

26. The flexible protocol engine of claim 25, further comprising an input line for allowing re-setting of the FPGA through the FPGA reprogramming section.

27. The flexible protocol engine of claim 20, further comprising a USB FIFO interface for retrieving data from the device interface and delivering data to the device interface.

28. The flexible protocol engine of claim 20, wherein the programmable components further comprise a control path for providing an interface to a driver.

29. The flexible protocol engine of claim 20, further comprising at least one input/output line for accepting programming from a firmware downloading component associated with a device driver.

30. A interface card for operation with multiple communication protocols, the interface card comprising:
a flexible protocol engine operable to process data by implementing a selected technique, the selected technique selectable from multiple selectable techniques, each of the multiple selectable techniques corresponding to a distinct communication protocol;
a line interface unit operatively connecting the flexible protocol engine to remote locations; and
an interfacing device connecting the flexible protocol engine with a host device.

31. The interface card of claim 30, wherein the flexible protocol engine comprises a programmable FPGA.

32. The interface card of claim 31, wherein the FPGA accepts reprogramming upon protocol detection.
